(19) United States
(12) Patent Application Publication
(10) Pub. No.: US 2019/0366488 A1
(43) Pub. Date: Dec. 5, 2019

(54) MOUNTING MEMBER FOR HEAT TREATMENT

(71) Applicant: KYOCERA Corporation, Kyoto-shi, Kyoto (JP)

(72) Inventor: Hiroshi HAMASHIMA, Hikone-shi, Shiga (JP)

(21) Appl. No.: 16/476,523

(22) PCT Filed: Jan. 10, 2018
(86) PCT No.: PCT/JP2018/000324

§ 371 Date: Jul. 8, 2019

(30) Foreign Application Priority Data
Jan. 10, 2017 (JP) 2017-002007

(51) Int. Cl. B23K 37/04; F27D 3/12; B23K 1/008

(52) U.S. Cl. CPC B23K 37/04; B23K 1/008; F27D 3/12

(57) ABSTRACT

A mounting member for heat treatment having a mounting surface for a target object includes a zirconia-based ceramic including zirconia crystals, and a columnar body including zirconium as a main component and present on at least a part of the mounting surface.

### TECHNICAL FIELD

The present disclosure relates to a mounting member for heat treatment.

### BACKGROUND ART

Conventionally, in a heat treatment apparatus such as a solder reflow furnace, a mounting member for heat treatment for mounting and conveying a target object is used. For example, according to Patent Document 1, a zirconia-based ceramic is used as the mounting member for heat treatment.

### PRIOR ART DOCUMENT

### Patent Document

Patent Document 1: Japanese Unexamined Utility Model Application Publication No. 5-82922

### SUMMARY OF THE INVENTION

The mounting member for heat treatment of the present disclosure is a mounting member for heat treatment having a mounting surface for a target object, the mounting member including a zirconia-based ceramic including zirconia crystals, and a columnar body including zirconium as a main component and present on at least a part of the mounting surface.

### BRIEF DESCRIPTION OF THE DRAWINGS

FIG. 1 is an electron micrograph of an example of a mounting surface of a mounting member for heat treatment of a present embodiment.

FIG. 2 is a micrograph of a cross section of the mounting member for heat treatment of the present embodiment.

FIG. 3 is a micrograph expanding an A section illustrated in FIG. 2.

### EMBODIMENTS FOR CARRYING OUT THE INVENTION

Hereinafter, an embodiment of the present invention will be described in detail with reference to the drawings (in the present case, photographs). However, in all the drawings of the present specification, the same reference numerals are given to the same parts unless causing confusion, and the description thereof will be omitted as appropriate.

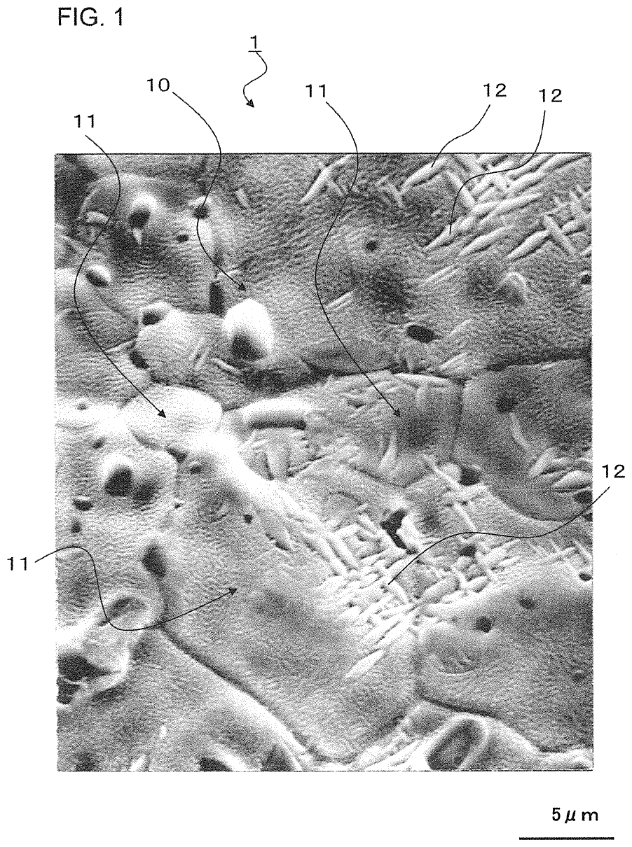

FIG. 1 is an electron micrograph of an example of a mounting surface 1 of a mounting member 10 for heat treatment (hereinafter, also simply referred to as mounting member 10) of the present embodiment. The mounting member 10 of the present embodiment is used to heat-treat a mounted target object, and includes a zirconia-based ceramic including zirconia crystals. Here, the zirconia-based ceramic refers to a ceramic in which a content, which is a value obtained by converting zirconium (Zr) into zirconia (zirconium oxide: ZrO₂), accounts for 80% by mass or more in 100% by mass of components constituting the ceramic. The presence of zirconia crystals can be confirmed by measurement with an X-ray diffractometer (XRD) and identification by comparison with a JCPDS card.

The mounting member for heat treatment including the zirconia-based ceramic is excellent in wear resistance, cracking resistance, and heat resistance. However, on the other hand, since an insulation property thereof is also high, for example, if the mounting member for heat treatment is charged with static electricity by repeated conveyance of an electronic component as a target object of heat treatment, the static electricity that the mounting member is charged with may damage the electronic component to be mounted next. Further, there is a possibility that dust in the air adheres to the target object of heat treatment due to the static electricity that the mounting member is charged with.

In the mounting member 10 of the present embodiment, a columnar body 12 including zirconium as a main component is present on at least a part of the mounting surface 1. Note that the columnar body 12 may include zirconium in an amount of 100% by mass. Since the mounting member 10 of the present embodiment satisfies the above-described configuration, current easily flows on the surface of the mounting surface 1. That is, in the mounting member 10 of the present embodiment, electrical resistance of the mounting surface 1 is reduced by the presence of the columnar body 12. Accordingly, the mounting surface 1 is less likely to be charged with static electricity, and there is a small risk of damaging the electronic component to be mounted. Further, since the mounting surface 1 is less likely to be charged with static electricity, there is also a small risk of adhesion of dust to the target object. Furthermore, even if the target object is electrostatically charged, mounting can make it easy to release the static electricity that the target object is charged with.

Here, the content of zirconium in the columnar body 12 can be confirmed by the following method. First, the mounting surface 1 is observed with a scanning electron microscope (SEM), so as to confirm the presence of columnar bodies with an aspect ratio (long diameter (length of the longest portion)/short diameter (length of a portion orthogonal to a middle of the long diameter) of 2 or more. Next, for a columnar body whose presence has been confirmed, the content of zirconium is confirmed by using an energy dispersive X-ray spectrometer (EDS) or a wavelength dispersive X-ray spectrometer (WDS) attached to the SEM. At this time, when the content of zirconium is 70% by mass or more, it can be said that the columnar body 12 in the present embodiment includes zirconia as a main component.

The average value of long diameters of the columnar bodies 12 is, for example, 2 μm or more and 4 μm or less, and the long diameter, the short diameter, and the aspect ratio of the columnar bodies 12 can be determined in accordance with JIS R 1670: 2006. Specifically, a target of observation may be the range of an area of 2.5×10⁵ μm² (for example, the length in the horizontal direction is 606 μm, and the length in the vertical direction is 410 μm). Further, the number of samples for calculating the average value may be 5 or more.

A region having a plurality of columnar bodies 12 may be included as illustrated in FIG. 1. Note that including a region that has a plurality of columnar bodies 12 refers to, for example, a region where 10 or more overlapping columnar bodies 12 are confirmed in the range of an area of 2.5×10⁵ μm² (for example, the length in the horizontal direction is 606 μm, and the length in the vertical direction is 410 μm). Specifically, it means regions at a lower right portion in the center and an upper right portion in FIG. 1. In a region where a plurality of columnar bodies 12 are present, electrical resistance of the mounting surface 1 is significantly reduced over a relatively wide range by the overlapping columnar bodies 12. When having such a region where a plurality of columnar bodies 12 are present, flow of current along the surface is more facilitated.

Further, in the mounting member 10 of the present embodiment, the zirconia-based ceramic may include at least one of magnesium oxide, cerium oxide, and scandium oxide. In magnesium, cerium, and scandium, which constitute magnesium oxide, cerium oxide, and scandium oxide, respectively, an ionic radius of metal element is larger than the ionic radius of zirconium ion (Zr²⁺), and a difference of an ionic radius from the ionic radius of zirconium ion (Zr²⁺) is less than or equal to 0.015 nm.

Accordingly, when the above configuration is satisfied, for example, in a state of being at a temperature of 200 to 450° C., the surface electrical resistance is further reduced. This reduction is conceivably because, as the temperature in the heat treatment increases, zirconium in the zirconia crystal is partially substituted with, for example, magnesium having a large ionic radius, thereby increasing conductive ions (zirconium) associated with oxygen defects in zirconia, and reducing the electrical resistance. Then, in the present embodiment, the columnar bodies 12 which have zirconium as a main component are provided on the mounting surface 1, and the columnar bodies 12 function as a bypass route (of conductive ions) of current on the mounting surface 1. Thus, the conductive ions generated on the mounting surface 1 easily flow (the current easily flows), and the electrical resistance is reduced to an effective level at which static electricity can be removed.

The mounting member 10 of the present embodiment has specific volume resistance of 1 Ω·m or more and 10⁶ Ω·m or less, for example, in a relatively low heat treatment temperature range of 200 to 450° C.

Such an element substituted for zirconium is likely to be metal ions having an ionic radius difference of 0.015 nm or less with respect to zirconium ion (Zr²⁺). Particularly when including magnesium oxide, cerium oxide, or scandium oxide, zirconium is easily substituted by magnesium, cerium, or scandium, and static electricity can be effectively reduced. Note that the ionic radius herein refers to so-called Shannon ionic radius described in R. D. Shannon, “Revised effective ionic radii and systematic studies of interatomic distances in halides and chalcogenides.”, Acta Cryst. Volume 32, Part 5, 751-767 (September 1976).

Further, including at least one of magnesium oxide, cerium oxide, and scandium oxide in the zirconia-based ceramic means including a raw material to be at least one of magnesium oxide, cerium oxide, and scandium oxide. The above-mentioned raw material serves as an auxiliary agent in sintering of the zirconia-based ceramic and acts as a stabilizer of zirconia crystals. Thus, the mounting member 10 of the present embodiment, which includes the zirconia-based ceramic including at least one of magnesium oxide, cerium oxide, and scandium oxide, is excellent in mechanical strength and fracture toughness. Further, phase transition of zirconium oxide is also suppressed by the action as a stabilizer, and the thermal shock resistance is also relatively high. From the viewpoint of effectively removing static electricity and increasing mechanical strength, the content of magnesium, cerium, and scandium in 100% by mass of components constituting the ceramic is, for example, 2% by mass or more and 6% by mass or less by the sum of values obtained by converting magnesium to magnesium oxide, cerium to cerium oxide, and scandium to scandium oxide, for example.

Note that in the zirconia-based ceramic, the content of each of zirconium, magnesium, cerium, scandium, and silicon in the zirconia-based ceramic converted into an oxide can be determined by determining the content of each element with an X-ray fluorescence (XRF) analyzer or an ICP (Inductively Coupled Plasma) optical emission spectrometer (ICP), and converting the content of each element into ZrO₂, MgO, CeO₂, Sc₂O₃, and SiO₂.

In addition to zirconium oxide, magnesium oxide, cerium oxide, scandium oxide, and silicon oxide, the components constituting the zirconia-based ceramic may include aluminum oxide, calcium oxide and the like.

Moreover, the mounting member 10 of the present embodiment may include zirconium silicate. When such a configuration is satisfied, zirconium silicate is present mainly in a grain boundary phase, and abnormal grain growth of zirconium oxide crystals is suppressed. Thus, high mechanical strength is provided. In the mounting member 10 of the present embodiment, a value obtained by converting silicon into silicon oxide is, for example, 0.3% by mass or more and 0.6% by mass or less. Note that confirmation of the presence of zirconium silicate may be performed by measurement by XRD and identification by comparison with the JCPDS card.

Further, the mounting member 10 of the present embodiment may include steatite (MgO.SiO₂) or forsterite (MgO.2SiO₂), which is generated by combining silicon oxide and magnesium oxide. Since steatite and forsterite have low thermal conductivity, when including steatite and forsterite, temperature changes of the mounting member 10 accompanying temperature changes of the surrounding atmosphere are suppressed.

Examples of a heat treatment apparatus in which the mounting member 10 of the present embodiment is used include heat treatment apparatuses such as a reflow soldering apparatus, a low frequency induction heating apparatus, a high-speed heat treatment apparatus, a sheet type clean oven, and an electric furnace. The heat treatment apparatus in which the mounting member 10 of the present embodiment is used is not particularly limited. As described above, the mounting member 10 according to the present embodiment has a sufficiently low specific volume resistance of, for example, 1 Ω·m or more and 10⁶ Ω·m or less, even in a relatively low heat treatment temperature range of, for example, 200 to 400° C., and thus static electricity can be reduced even in a heat treatment at temperatures around that of a solder reflow process in a solder reflow furnace. The shape of the mounting member 10 is, for example, planar, rectangular, or columnar and is not particularly limited, and may be a shape according to a use form in the heat treatment apparatus.

Further, the crystal phase of the zirconia crystal may have a tetragonal ratio of 96% or more. When the tetragonal ratio of the crystal phase of the zirconia crystal is in this range, the thermal shock resistance can be improved.

A tetragonal ratio ft may be calculated from the area of each peak intensity I of the zirconia crystal with XRD using the following equation.

ft(%)=[It(111)]×100/[Im(111)+Im(11−1)+It(111)+Ic(111)]

Here, subscripts m, t, and c indicate monoclinic, tetragonal, and cubic, respectively.

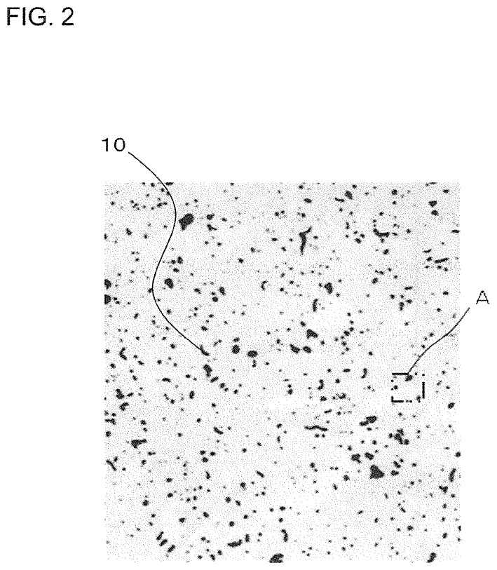

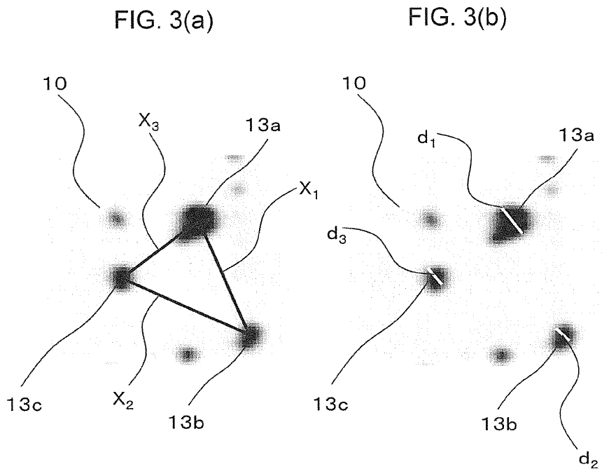

FIG. 2 is a micrograph of a cross section of the mounting member 10 of the present embodiment. Further, FIG. 3 is a photograph expanding an A section illustrated in FIG. 2. As illustrated in FIGS. 2 and 3, the mounting member 10 of the present embodiment has a plurality of pores 13 inside, and a value obtained by subtracting an average value of equivalent circle diameters of the pores 13 from an average value of distances between centers of gravity of the pores 13 may be 5 μm or more and 15 μm or less.

In such a configuration, when heating and cooling are repeated in the heat treatment apparatus, extension of microcracks generated by thermal stress is likely to be blocked by the pores 13. Further, since extension of the microcracks is suppressed, decrease in mechanical strength is suppressed, that is, the mechanical strength is maintained.

Further, an average value of circularity of the pores 13 may be 0.84 or more. With such a configuration, since shapes of the pores 13 are nearly spherical, stress concentration near the pores 13 is less likely to occur, and the mounting member 10 can be used for a long period of time.

The method of measuring the distances x1, x2, x3, . . . between the centers of gravity of the pores 13a, 13b, 13c, . . . is as follows. First, an optical microscope is set to a magnification of 200 times. Then, a cross section of the zirconia-based ceramic is polished with diamond abrasive grains into a mirror surface serving as a target of measurement. From this mirror surface, a portion where the size and distribution of pores 13 are observed on average is selected, and with the target of observation being the range of an area of 2.5×10⁵ μm² (for example, the length in the horizontal direction is 606 μm, and the length in the vertical direction is 410 μm, a method called a gravity center distance method of image analysis software “A-Zo Kun (ver. 2.52)” (“(registered trademark, manufactured by Asahi Kasei Engineering Corporation, hereinafter, simply described as image analysis software) is applied.

Further, as a method of measuring the circularity of pores 13a, 13b, 13c, . . . , a method called particle analysis of the image analysis software is applied with the above image being the target of observation. Setting conditions of the gravity center distance method and the particle analysis are such that lightness of particles is dark, a method of binarization is slide, a threshold value is 190, and a small figure removal area and a noise removal filter are enabled. Then, the distances x1, x2, x3, . . . between centers of gravity of the pores 13a, 13b, 13c, . . . and equivalent circle diameters d1, d2, d3, . . . are determined by the method described above, and the average values x, d can be calculated.

Note that although the threshold value is set to 190 as an example when analyzing FIG. 3, the setting of the threshold value may be adjusted according to brightness of screen, and the setting of the threshold value may be adjusted so that a marker appearing on the screen matches the shapes of pores.

Next, an example of a manufacturing method of the mounting member 10 of the present embodiment will be described.

First, a powder of zirconium oxide, a powder of at least one of magnesium oxide, cerium oxide, and scandium oxide, and a powder of silicon oxide are prepared. Here, the content of the powder of at least one of magnesium oxide, cerium oxide, and scandium oxide is, for example, 2% by mass or more and 6% by mass or less in a total of 100% by mass of the aforementioned powders. Moreover, a content of the powder of silicon oxide is, for example, 0.3% by mass or more and 0.6% by mass or less among 100% by mass of the total of the aforementioned powders.

Then, these powders are wet-mixed and ground using a barrel mill, a rotary mill, a vibration mill, a bead mill, a sand mill, an agitator mill, or an attritor or the like to obtain slurry. Here, a solvent used for wet mixing is, for example, 75 parts by mass and 85 parts by mass or less with respect to the total of 100 parts by mass of the aforementioned powders. Note that 4 parts by mass or more and 8 parts by mass or less of an organic binder such as polyvinyl alcohol (PVA) and 0.1 parts by mass or more and 0.5 parts by mass or less of a dispersant are also introduced into the stirrer with respect to 100 parts by mass of the solvent. Resulting slurry is spray dried to obtain granules.

Here, in order to adjust the average value of circularity of the pores, it may be adjusted by a grinding time using a bead mill. Further, a value obtained by subtracting the average value of circle equivalent diameters of the pores from the average value of distances between gravity centers of the pores may be adjusted with the addition amount of a dispersing agent.

Then, the granules are formed into a molded body of a predetermined shape by a dry pressure molding method or cold isostatic pressing (CIP) method. The molded body is placed in a firing furnace and sintered by being held for 1 hour or more and 3 hours or less at a temperature of 1500° C. or more and 1680° C. or less in an air (oxidative) atmosphere, and thereafter cooled down. While this cooling at the time of the sintering, when a temperature range of 400° C. to 800° C. is reached, air at a temperature of about the room temperature is supplied into the firing furnace to quench the inside of the firing furnace, and thus the mounting member 10 having the columnar bodies 12 on a surface can be obtained. The generation of the columnar bodies 12 by this temperature profile (cooling profile) is a finding obtained for the first time by the inventor of the present invention.

The embodiment of the present invention has been described above, but the present invention is not limited to the above embodiment, and it goes without saying that various improvements and changes may be made without departing from the scope of the present invention.

### DESCRIPTION OF THE REFERENCE NUMERAL

1: Mounting surface
10: Mounting member
11: Zirconia crystal
12: Columnar body
13: Pore

1. A mounting member for heat treatment having a mounting surface for a target object, the mounting member comprising:
a zirconia-based ceramic including zirconia crystals; and
a columnar body including zirconium as a main component and present on at least a part of the mounting surface.

2. The mounting member for heat treatment according to claim 1, wherein the zirconia-based ceramic includes at least one of magnesium oxide, cerium oxide, and scandium oxide.

3. The mounting member for heat treatment according to claim 2, wherein a sum of values obtained by converting magnesium into magnesium oxide, cerium into cerium oxide, and scandium into scandium oxide ranges from 2% by mass to 6% by mass of the zirconia-based ceramic.

4. The mounting member for heat treatment according to claim 1, wherein the zirconia-based ceramic includes zirconium silicate.

5. The mounting member for heat treatment according to claim 1, wherein the zirconia-based ceramic has a plurality of pores inside, and a value obtained by subtracting an average value of circle equivalent diameters of the plurality of pores from an average value of distances between centers of gravity of the plurality of pores ranges from 5 μm to 15 μm.

6. The mounting member for heat treatment according to claim 5, wherein the plurality of pores have an average value of circularity of 0.84 or more.
